(19) United States
(12) Patent Application Publication
(10) Pub. No.: US 2005/0217659 A1
(43) Pub. Date: Oct. 6, 2005

(54) Outdoor cooker having improved heat and combustion gas controls

(76) Inventor: James McClenahan, New Castle, PA (US)

Correspondence Address: Robert G. Lev, 4766 Michigan Boulevard, Youngstown, OH, 44505, US

(21) Appl. No.: 10/815,433

(22) Filed: Apr. 1, 2004

(51) Int. Cl. F24B 3/00; A47J 37/00

(52) U.S. Cl. 126/25 R; 126/307 R

(57) ABSTRACT

An improved outdoor cooker contains a number of expedients for controlling temperature and diverting combustion byproducts such as ash and noxious gases away from the cooking area. The temperature is controlled using a convection plate, an extended chimney flue and a secondary chimney on a removable hood. Controls are provided to balance smoke, steam and heat.

### FIELD OF THE INVENTION

The present invention generally relates to barbecue grills for outdoor cooking. In particular, the present invention is directed to an outdoor cooking system having improved control of heat and control of noxious gases.

### BACKGROUND OF THE ART

Barbecue grills and other outdoor cookers are well known in the conventional art. A wide variety of different shapes and configurations are used for barbecue grills and outdoor cooking systems. In a typical outdoor cooking system, food is placed on a fixed grill surface (or one of a number of such surfaces), which is exposed to a source of heat such as a fire. In most conventional grills, whether it is charcoal fueled, wood fueled, or gas fueled, the source of heat is fixed. In some cases two sources of heat are available. However, it is always awkward to move a heat source in relationship to the cooking surfaces grill. This is especially problematical if the spacing between the heat sources and the grill is substantial or not easily configured.

There is always the problem of uneven cooking of the food to be prepared, even if vigilance is exercised in monitoring the grill and moving the food around the cooking surface to provide uniformed cooking. Further, in many cases (such as wood fires) the heat source may be variable, further complicating the job of the cook.

Another problem known to all open-flame grills is the phenomenon of “flare up”. This occurs when fats and oils which liquefy upon heating, are deposited on the heat source where they can ignite and smoke. Upon ignition, an area of increased, combustion occurs, potentially charring the food immediately above it, and further complicating the cooks efforts to keep the food over the proper amount of heat. Because of this and the possibility of uneven combusting in the heat source, some areas of the grill will be relatively hot while others are relatively cool. With the conventional art, none of this is easily controlled.

A number of attempts have been made to mitigate the problem of uneven combustion, and subsequent uneven heating of the cooking surface. One solution is to provide a movable grill surface to automatically move the food around the fire source. Another method is to modify the intake of air and fuel mixture for altering the rate at which the fuel burns. A further conventional solution is to provide a mechanism for raising and lowering the fuel source to compensate for varying rates of fuel consumption.

All of these are awkward since they most often involve mechanical operations that must take place at relatively high temperatures, thereby complicating and raising the expense of any mechanisms that are used for this purpose. However, even with accurate and complex mechanisms for detecting heat level and moving the cooking surface to maintain food at predetermined cooking temperatures, it is often very difficult to place the food at the correct place on the cooking surface for the amount of heat desired to cook the food.

Even if the proper position of the food could be maintained, the cooking temperature is still subject to the vagaries of the fire box, if wood or charcoal are being used. Unfortunately, the control that is achieved in most conventional grills must take into account the entire grill system and the relationship between the fire box (or heat source) and the cooking surface. Since so many factors are involved in the entire system it is relatively difficult to obtain precise control at the cooking surface, where the food is located. Very often, several adjustments must be made through out the cooking system in order to find the right temperature and move the food to the appropriate location.

Another crucial attribute in conventional grills is the generation of noxious gases and airborne ash. This can occur with most fire boxes, especially where a combination of fuels are combusted. It can also occur when fat from meat drips onto a hot combustion box. Very often, when the fat drips on to the combustion box flare ups occur and noxious gases rise up immediately back into the food. This is a chief reason that health professionals speak out strongly against frequent use of outdoor grills.

Unfortunately, the conventional art has done very little to provide precise heat control where the food is actually being cooked. Further, there has been very little done to control the generation of noxious gases and airborne ash. Accordingly, any advance in the design and operation of outdoor grills would include structures and techniques which limit the generation of noxious gases and ash and draw those byproducts that are generated away from the food and away from the cook. Further improvements would also include techniques for rendering heat provided by the combustion box, or heat source more uniform and accurately controlled. Also, such an improved system would address moisture and smoke balance for smoking operations.

### SUMMARY OF THE INVENTION

Accordingly it is one object of the present invention to provide an outdoor cooking system that overcomes the drawbacks of the conventional art.

It is another object of the present invention to control the heat to which the food is actually exposed in an outdoor cooking system.

It is a further object of the present invention to control temperature at the cooking surface of an outdoor cooker without having to adjust the rate of combustion in the system.

It is an additional object of the present invention to limit the generation of noxious gases in an outdoor cooking system.

It is yet another object of the present invention to provide an outdoor cooking system capable of removing noxious gases and controlling ash that are generated from the combustion process while minimizing exposure of the food and the cook to such combustion byproducts.

It is still a further object of the present invention to provide uniform heat to the cooking area of an outdoor cooking system.

It is yet an additional object of the present invention to provide an outdoor cooking system having temperature control to the area around the cooking surface without adjusting combustion.

It is still another object of the present invention to keep food drippings away from the combustion box in an outdoor cooking system, thereby eliminating substantial generation of noxious gases.

It is again a further object of the present invention to provide a cooking system in which smoke is controlled so that it can be applied to the food, or exhausted in virtually any amount.

It is still a further object of the present invention to provide a cooking system which combines smoking and steam in predetermined balanced amounts.

It is again another object of the present invention to provide an outdoor cooking system that can be self-cleaning.

It is still another goal of the present invention to provide a cooker in which simple techniques can be used to protect food from ash and other undesirable combustion byproducts.

It is again an additional goal of the present invention to provide an outdoor cooking system capable of smoking poultry without causing the skin to disintegrate.

It is yet a further object of the present invention to provide an outdoor cooking system having controls that permit a combination of smoking and steam cooking, which can be adjusted depending upon the food to be cooked.

These and other goals and objects of the present invention are achieved by a cooker for outdoor use having a body with a removable hood at the top of the body. The body contains a fire box adjacent to the bottom of the body, and the body has a chimney extending through the top of the body. The body also contains a cooking surface located under the hood. Further included is a structure for covering the fire box to prevent contact with food drippings from the cooking surface and for diverting combustion gases and solids from the cooking surface.

In another embodiment a cooker for outdoor use has a body with a removable hood at the top of the body. The body contains a fire box adjacent to the bottom portion of the body and a chimney extending through the top of the body. Also included is a cooking surface under the hood. The cooker further includes an extended flue device for diverting combustion gases and solids from the cooking surface.

In a further embodiment of the present invention a cooker for outdoor use includes a body with a removable hood at the top of the body. The body contains a fire box adjacent to the bottom portion of the body. The cooker also includes a primary chimney extending through the top of the body, and a cooking surface under the hood. The cooker further includes an outlet device for controlling the cooking temperature of the area around the cooking surface.

In still another embodiment of the present invention a cooker for outdoor use includes a body with a removable hood at the top of the body and a fire box adjacent the bottom of the body. The cooker also includes a primary chimney extending through the top of the body, and a cooking surface under the hood. The cooker further includes a system for balancing steam, smoke and heat under the hood near the cooking surface.

### BRIEF DESCRIPTION OF THE DRAWINGS

FIG. 1 is a front view of the grill without the hood over the cooking area.

FIG. 2 is a front view of the grill including the hood and secondary chimney over the cooking area.

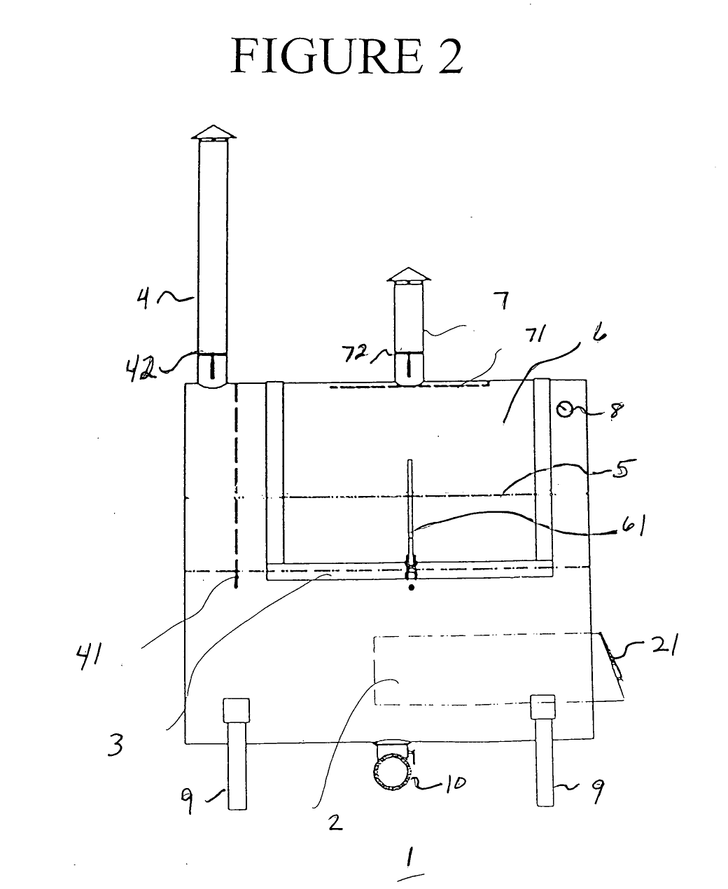

FIG. 3 is a side view of the grill depicting the location of the hood when in the closed position.

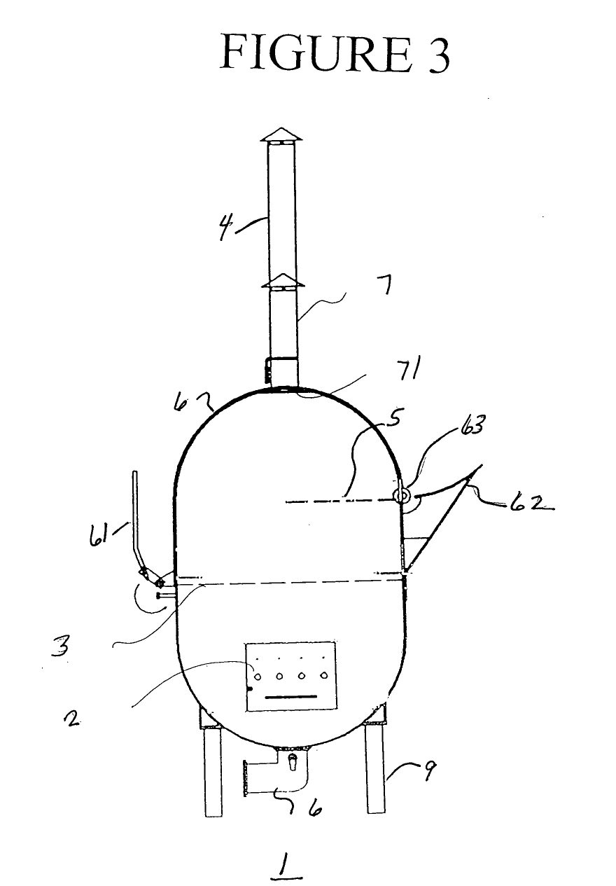

### DETAILED DESCRIPTION OF THE PREFERRED EMBODIMENTS

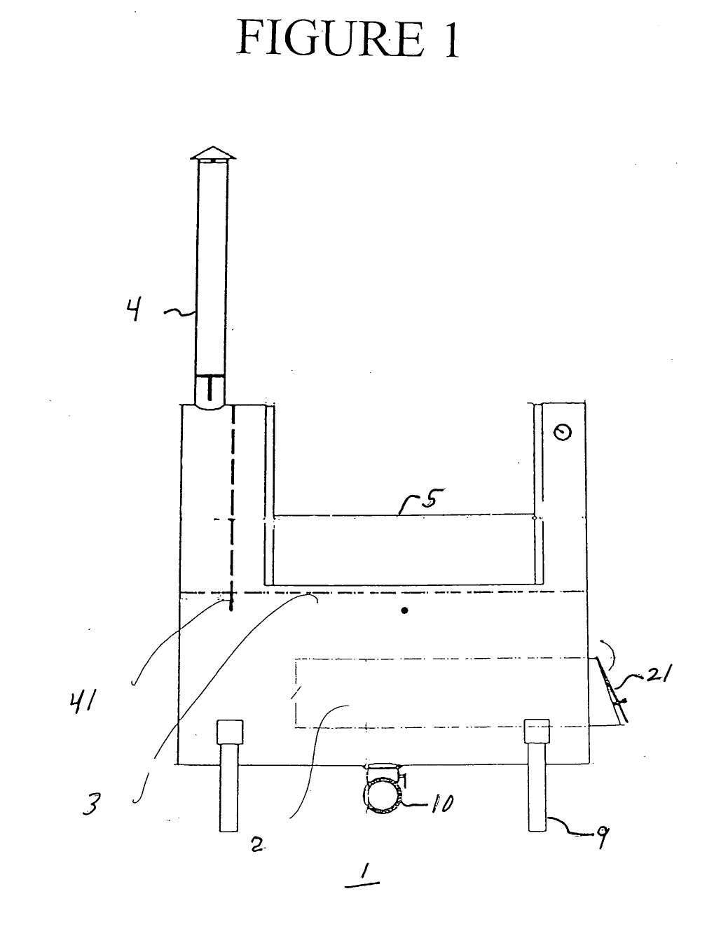

FIG. 1 depicts the most basic aspects of the inventive grill or outdoor cooker 1. A number of the elements constituting grill 1 are standard. For example, legs 9 hold the semi-cylindrical grill off the ground, providing room for ash disposal vent 6. While four legs 9 are shown, any arrangement that holds the structure off the ground can be used with the present invention. The general shape of the grill is shown as being semi-cylindrical. However, virtually any shape can be used within the concept of the present invention.

Fire box 2 is a standard structure well known in the conventional art. Access to the fire box is gained using an opening lid 21. The lid is extended and mounted at a slight angle so that it closes automatically. This is a standard safety precaution well known in the conventional art. Ash is also removed via lid 21.

The fire box 2 is sealed except for the top which is open. However, this is covered by-convection plate 3 which is approximately one inch above the top of the fire box. The solid sides and bottom of the fire box are sealed, except for the lid 21, which extends beyond the overall body of grill 1. Preferably, the fire box is sealed against moisture except for its open top. Fire box 2 is located approximately sixteen inches from the bottom of the grill 1. Both the lower part of grill 1 and the combustion box are constructed to prevent the migration of moisture.

One of the advantages of the present invention is that the lower portion of the grill 1 can be filled with water, usually from the top. Moisture is prevented from entering fire box 2 by convection plate 3. Rather, the water will pour over the plate at its outer edges to the bottom of the cooker.

The water can be used to generate steam to clean the entire grill interior by having a substantial fire in fire box 2 while keeping hood 6 closed. The generation of steam will create pressure that will help cook off food and combustion byproducts. The water and the dissolved byproducts that will accumulate in the water can be drained using elbow drain 10. The advantage is that the vast majority of impurities will collect at the bottom of the grill and be washed away by the water flowing out of drain 10.

While the cleaning function can be very important, it is ancillary to the steam cooking function provided in grill 1. Normally, the grill is filled with water up to approximately three to five inches above the bottom of fire box 2, which is approximately sixteen inches above the bottom of grill 1. At this level, the bottom of main chimney flue 41 is still at least one inch above the water, and so will not be blocked. The inside of the grill will fill with steam and smoke, both of which filter upwards around the periphery of convection plate 3. The presence of the steam with the smoke mitigates the normal drying effects of the smoke.

Normally, when smoke is applied with insufficient moisture, a certain amount of drying takes place in the food that is being cooked. By adding additional moisture, these effects are altered. For example, in a normal smoking process, poultry skin is entirely desiccated, leaving a blackened parchment. With the present invention, this does not happen. While the poultry skin will shrink somewhat, there's only a 7-15% shrinkage rate. The skin still remains whole and the meat underneath remains more moist.

The capability of maintaining a high level of moisture while smoking is even more important with such foods as fish, or crustaceans. The level of steam is not really controlled by main chimney 4. Rather, it is maintained by auxiliary chimney 7. Much of the smoke is exhausted through main chimney 4. However, this can be controlled by damper 42, just as the level of steam is controlled by damper 71 on auxiliary chimney 7. This balancing between the levels of smoke and steam is a capability not found in conventional outdoor cooking systems.

Since fire box 2 is arranged with an open top, fat which drips down from the cooking surface 5 would produce flare ups and noxious gases as it strikes the fire.

The dripping fat is intercepted by convection plate 3, which covers almost the entire horizontal area of grill 1. There is approximately one inch of space between convection plate 3 around the inner periphery of grill 1. There is also a substantial opening in convection plate 3 to accommodate the lower flue 41 of primary chimney 4. Convection plate 3 can be between one and four inches from fire box 2.

Besides stopping drippings from cooking food from entering fire box 2, convection plate 3 absorbs and uniformly transmits the heat from fire box 2. Even if combustion within the fire box is extremely uneven, the fire box will heat convection plate 3, which will distribute the heat evenly through its mass, and evenly heat any food on food surface 5. Further, when hood 6 is put in place overlooking cooking surface 5, the entire area will be heated uniformly by convection plate 3. Not only are flare ups eliminated by convection plate 3, but the even heat distribution afforded by convection plate 3 will mitigate any uneven combustion in combustion box 2.

Uneven or irregular combustion can still occur. However, the extended flue 41 of primary chimney 4 serves to remove many of the byproducts of uneven combustion. The fact that the flue 41 is adjacent to the fire box (between one and three inches above the fire box) means that much combustion gas is exhausted while the heat radiates immediately upwards from the combustion box 2 to convection plate 3.

Hood 6 allows the space around cooking surface 5 to be at a high steady temperature. However, this temperature must be adjusted based upon the food to be cooked. This temperature is controlled by secondary chimney 7. Baffle plate 71 is arranged immediately under secondary chimney 7 at a space of one inch or less clearance between baffle plate 71 and the top of the hood 6. By adjusting the secondary chimney damper 72 the heat contained under hood 6 can be closely controlled through the mitigating influence of the baffle plate 71. Steam contents is controlled in the same manner since most steam bypasses the extended chimney flue 41, as does much of the smoke. This means that the heat, smoke and moisture can be carefully controlled without influencing the combustion process through extensive adjustments to primary chimney damper 42.

Hood 6 is operated to gain access to cooking surface 5 by means of a handle 61 with which the hood is thrown back. The hood is held in an open position by support 62, once it had rotated fully on pivot mechanism 63.

Both chimneys 4, 7 can be controlled by means of standard closures or dampers 42 and 72. In the case of the primary chimney 4, the damper 42 will regulate the combustion process in combustion box 2 to a substantial extent. On the other hand, secondary chimney 7 will control the amount of heat that is contained or permitted to be dissipated from beneath hood 6. In the same manner, steam and smoke are controlled.

The use of both dampers 42, 72 permits a balance of heat, steam, and smoke to be maintained under the hood 6 so that the food on the cooking surface 5 can be treated in the most appropriate manner. In particular, this adjustment can take place without opening hood 6, an action that might compromise the cooking conditions underneath the hood. Adjustments of the two dampers can be carried out responsive to moisture and temperature indicators (not shown), that sense conditions at the cooking surface 5. The present system permits a balance between temperature, smoke, and even moisture content to achieve optimum cooking/smoking conditions for each particular type of food to be cooked.

Because so much of the smoke can be kept in the cooker (due to near complete closure of damper 42), additional combustion byproducts, such as ash, can find its way under hood 6, and above cooking surface 5. Such a situation normally occurs when a maximum of smoke and steam are desired to be kept under hood 6.

Unfortunately, certain combustion byproducts, such as ash, are liable to settle on the food from above. To prevent this, all that need be done is the placement of tin foil or a similar material over the food on cooking surface 5. A protective layer is not needed beneath the food (as is required with most conventional outdoor cookers) since the convection plate 3 prevents the direct migration of combustion byproducts from below. Rather, the combustion byproducts must migrate around the edge of the convection plate to the top of hood 6, to be dropped onto the food. This would normally occur only when the vast majority of smoke is being held within the hood. High steam content very often effects precipitation of ash on the interior surfaces of the cooker.

While a number of embodiments have been disclosed by way of example, the present invention is not limited there to. Rather, the present invention should be construed to cover any and all variations, modifications, permutations, adaptations, derivations, and embodiments that would occur to one skilled in the present art, having been taught the present invention. Accordingly, the present invention should be limited only by the amended claims.

1. A cooker for outdoor use having a body with a removable hood at the top of the body, said body containing a fire box adjacent a bottom portion of said body, said body having a chimney extending though said top of said body, and a cooking surface located under said hood, said cooker comprising:
(a) means for covering said fire box to prevent contact with food drippings from said cooking surface and for diverting combustion gases and solids from said cooking surface.

2. The cooker of claim 1 wherein said means for covering and diverting comprise a convection plate extending over a majority of a horizontal area in said body over said fire box.

3. The cooker of claim 2, wherein said convection plate further comprises an opening for a chimney flue.

4. The cooker of claim 3, wherein said convection plate is approximately one to three inches above said fire box.

5. The cooker of claim 4, further comprising a first chimney flue extending beneath said convection plate.

6. The cooker of claim 5, further comprising means for generating steam.

7. The cooker of claim 6, wherein said means for generating steam comprise a body of water arranged in a bottom portion of said cooker and extending around a portion of said fire box.

8. The cooker of claim 7, further comprising means for draining said water from said cooker.

9. The cooker of claim 8, wherein said firebox has an open top, and sealed sides and bottom to stop migration of moisture.

10. A cooker for outdoor use having a body with a removable hood at the top of said body, and containing a fire box adjacent a bottom portion of said body, said cooker including a chimney extending through the top of said body, and a cooking surface under said hood, said cooker comprising:
(a) flue means for diverting combustion gases and solids from said cooking surface.

11. The cooker of claim 10, wherein said means for diverting comprise an extended chimney flue in close proximity to said fire box.

12. The cooker of claim 11, wherein the bottom of said extended chimney flue is approximately one to three inches above said fire box.

13. The cooker of claim 12, further comprising a convection plate arranged over said fire box.

14. The cooker of claim 13, wherein said convection plate is between one and three inches above said fire box, and contains an aperture for said extended chimney flue.

15. The cooker of claim 14, further comprising means for generating steam.

16. The cooker of claim 15, wherein said means for generating steam comprise a body of water rising to between two and seven inches below said extended chimney flue.

17. A cooker for outdoor use having a body with a removable hood at the top of said body, and containing a fire box adjacent a bottom portion of said body, said cooker also including a primary chimney extending through said top of said body, and a cooking surface under said hood, said cooker comprising:
(a) exhaust means for controlling cooking temperature of an area around said cooking surface.

18. The cooker of claim 17, further comprising means for generating steam.

19. The cooker of claim 18, wherein said means for generating steam comprise a body of water arranged in the bottom of said cooker.

20. The cooker of claim 19, wherein said exhaust means control steam content in said cooker.

21. The cooker of claim 20, wherein said exhaust means comprise a secondary chimney extending through a top of said hood.

22. The cooker of claim 21, further comprising a baffle plate mounted under said hood and beneath said secondary chimney.

23. A cooker for outdoor use having a body with a removable hood at the top of said body, and containing a fire box adjacent a bottom portion of said body, said cooker also including a primary chimney extending through said top of said body, and a cooking surface under said hood, said cooker comprising:
(a) means for balancing heat, smoke and steam in said cooker.

24. The cooker of claim 23, wherein said means for balancing comprise: a first chimney damper; a second chimney damper; an extended flue for at least one chimney; and a convection plate between a fire box and a cooking surface.
